(19) United States
(12) Patent Application Publication
(10) Pub. No.: US 2003/0137896 A1
(43) Pub. Date: Jul. 24, 2003

(54) MIXING ASSEMBLY AND METHOD FOR DISPENSING COLD WATER CONTAINING CO2

(76) Inventor: Margret Spiegel, Glinde (DE)

Correspondence Address: HENRY M FEIEREISEN, 350 FIFTH AVENUE, SUITE 3220, NEW YORK, NY, 10118, US

(21) Appl. No.: 09/507,194

(22) Filed: Feb. 18, 2000

Related U.S. Application Data
(63) Continuation of application No. PCT/DE98/02413, filed on Aug. 19, 1998.

(30) Foreign Application Priority Data
Aug. 20, 1997 (DE) 297 14 872.9
Feb. 16, 1998 (DE) 198 06 243.5
Jul. 4, 1998 (DE) 198 29 926.5

(51) Int. Cl. B01F 15/06

(52) U.S. Cl. 366/144; 99/275

(57) ABSTRACT

A mixing assembly includes a water tap connection with at least one cold water feed which is provided with a second cold water feed that is connected to a CO₂ supply. The CO₂ supply is connected by a CO₂ conduit to a metering station which is connected to the second cold water feed and is configured as a nozzle projecting in the second cold water feed and arranged radially to the second cold water feed. Provided between the metering station and the water tap connection is a mixer in the form of a static mixer. The second cold water feed is connected to the main water line, but can also be connected to the cold water feed by a branch pipe. Suitably, the second cold water feed is configured between the metering station and the water tap connection as a reaction conduit of e.g. helical shape.

### CROSS-REFERENCES TO RELATED APPLICATIONS

This application is a continuation of prior filed copending PCT International application no. PCT/DE98/02413, filed Aug. 19, 1998, and claims the priorities of German Patent Applications, Serial No. 297 14 872.9, filed Aug. 20, 1997, Serial No. 198 06 243.5, filed Feb. 16, 1998, and Ser. No. 198 29 926.5, filed Jul. 4, 1998, the subject matter of which is incorporated herein by reference.

### BACKGROUND OF THE INVENTION

The invention relates to a mixing assembly comprised of a water tap connection with at least one cold water feed. The invention further relates to a method for dispensing CO₂-containing cold water from water tap connections of mixing assemblies with at least one cold water feed.

Water tap connections, as used especially in kitchens and private households, typically include a cold water feed and a hot water feed, when used as mixing assembly. Cold water, hot water or mixed water can be dispensed via a spout. Operation of conventional water tap connections is realized in a two-handle faucet of a mixing assembly via two separate valves, or in a single-hand lever faucet of a mixing assembly via a common single-hand lever.

Devices are known for self-production of CO₂-containing drinking water or cold water, and are filled with cold water, whereby carbon dioxide is supplied via a CO₂ cartridge. Production of significant quantities of drinking water containing carbon dioxide with these devices is relatively complicated and expensive.

### SUMMARY OF THE INVENTION

It is thus an object of the present invention to provide an improved mixing assembly for dispensing cold water containing CO₂, obviating the afore-stated drawbacks.

In particular, it is an object of the present invention to so modify conventional mixing assemblies that carbon dioxide containing drinking water, i.e. cold water to which CO₂ has been added, can be dispensed in a simple and cost-efficient manner from a normal household water tap connection.

These objects, and others which will become apparent hereinafter, are attained in accordance with the present invention by providing a second cold water feed which is connected with a CO₂ supply.

As the water tap connection includes a second cold water feed which is connected to a CO₂ supply, carbon dioxide containing drinking water can be dispensed from a water tap connection in a simple and cost-efficient manner.

According to a preferred embodiment of the present invention, the CO₂ supply is connected via a CO₂ conduit with a metering station which is arranged in the second cold water feed. Disposed between the metering station and the water tap connection is a stationary mixer. In this manner, a thorough mixture of cold water with CO₂ can be realized in a simple and cost-efficient manner.

According to a further preferred embodiment of the present invention, the second cold water feed is configured as reaction conduit between the metering station and the water tap connection. An appropriate length of the reaction conduit ensures thereby a sufficient reaction time for optimum mixture of cold water and CO₂.

According to a further preferred embodiment of the present invention, the water tap connection is designed as two-handle faucet for mixing cold water and hot water with provision of an additional control member for the second cold water feed for dispensing cold water to which CO₂ has been added. Thus, water can be tapped by opening the respective control member in a conventional manner.

According to a further preferred embodiment of the present invention, the water tap connection is designed as single-hand lever faucet with an additional function for the second cold water feed for dispensing CO₂-containing cold water. Through an additional valve function, cold water to which CO₂ has been added can be dispensed via the single-hand lever without additional control element.

It is a further object of the invention to provide an improved cost-efficient method for dispensing CO₂-containing water from water tap connections, as used in particular in private households.

This object is attained in accordance with the invention in that CO₂ is fed from a CO₂ supply to a second cold water feed via a metering station, mixed with cold water and fed by an additional valve function to a spout of the water tap connection.

Thus, it is possible in a simple and cost-efficient way to dispense cold water, to which CO₂ has been added, from a water tap connection.

### BRIEF DESCRIPTION OF THE DRAWING

The above and other objects, features and advantages of the present invention will be more readily apparent upon reading the following description of a preferred exemplified embodiment of the invention with reference to the accompanying drawing, in which:

FIG. 1 is a schematic illustration of a mixing assembly as two-handle faucet with an additional control member for the second cold water feed;

FIG. 2 is a schematic illustration of a mixing assembly as two-handle faucet with additional control member for the second cold water feed with helical reaction conduit;

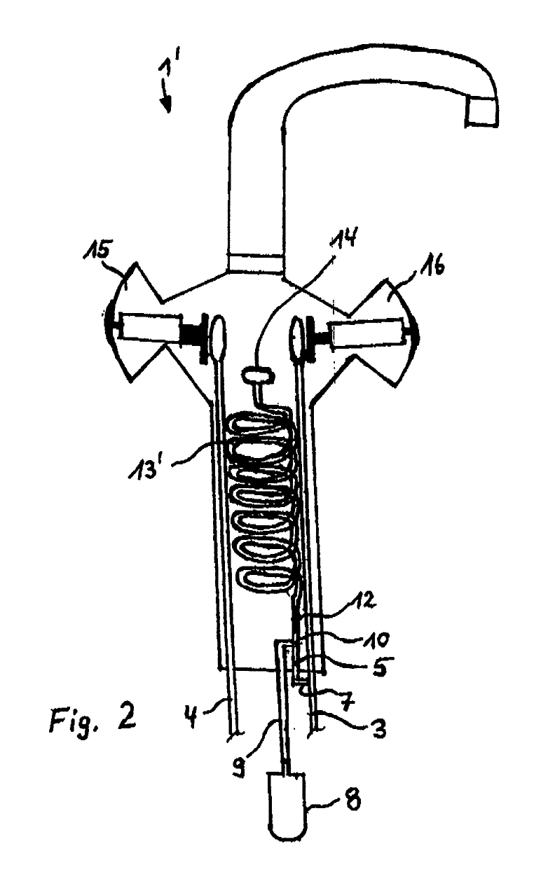

FIG. 3 is a schematic illustration of a mixing assembly as single-hand lever faucet with additional function for the second cold water feed;

FIG. 4 is a schematic illustration of a mixing assembly as two-hand lever faucet with a structural unit separable via detachable screw connections; and

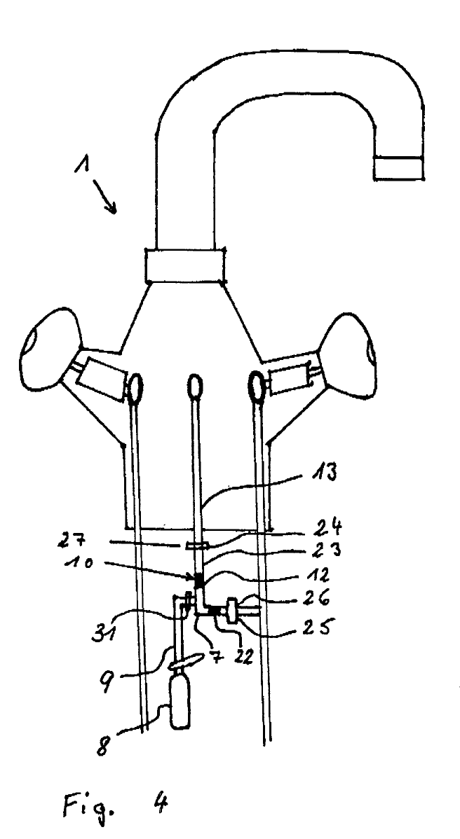

FIG. 5 is a schematic illustration of a mixing assembly as two-hand lever faucet with a squeeze-type connection in the area of the structural unit.

### DETAILED DESCRIPTION OF PREFERRED EMBODIMENTS

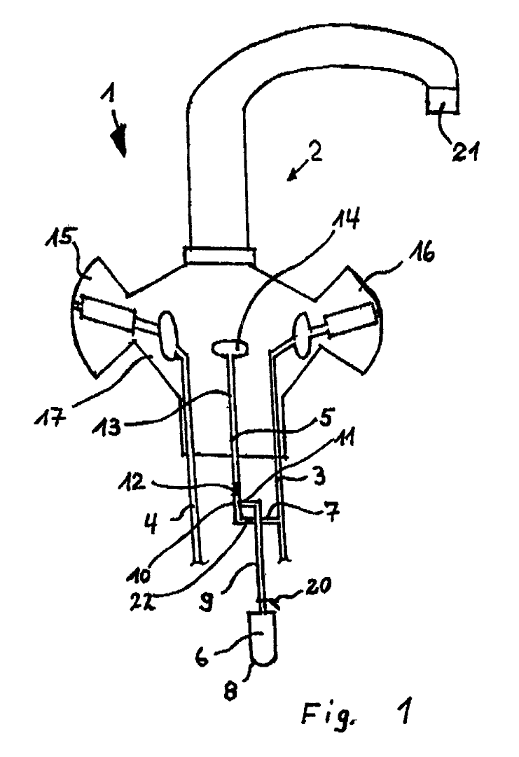

Turning now to the drawing, and in particular to FIG. 1, there is shown a mixing assembly 1 which essentially includes a water tap connection 2, a cold water feed 3, a hot water feed 4, a second cold water feed 5 and a CO₂ supply 6. The second cold water feed 5 is fed via a branch pipe 7 from the cold water feed 3. It is, however, also possible to connect or to feed the second cold water feed 5 directly to or from the main water line.

The CO₂ supply 6 is disposed in a CO₂ supply container 8. The CO₂ supply container 8 is connected by a CO₂ conduit 9 with a metering station 10 arranged in the second cold water feed 5. The metering station 10 is designed as nozzle 11, which projects into the second cold water feed 5 and is arranged radially to the second cold water feed 5.

Disposed behind the metering station 10 in the direction of the water tap connection 2 is a mixer 12, which is configured as static mixer. Suitable mixers include standard mixers similar to, for example, those made available by SULZER AG, Wintherthur, as so-called SULZER-mixer for CO₂ introduction for large-scale plants. The size of the known mixers must, however, be reduced for the purposes involved here. The mixer may, for example, be equipped with five mixing elements which have been installed in a pipe of nominal width 10.

The second cold water feed 5 is designed as reaction conduit 13 between the metering station 10 and the water tap connection 2. The reaction conduit 13 has a length which is matched to a reaction time for mixture of cold water and CO₂. The reaction conduit 13′ may be designed in the form of a helix to implement a sufficient length. The second cold water feed 5 includes a control member at the water tap connection. The control member may, for example, be designed as upper faucet part or faucet handle (not shown) of an auxiliary valve 14 for discharge of cold water mixed with CO₂. In this configuration, the water tap connection 2 is designed as two-handle faucet 17 of a mixing assembly for mixture of cold water and hot water with additional control member for the second cold water feed 5 for dispensing cold water to which CO₂ has been added. Hot water may thereby be operated in conventional manner via a hot water faucet handle 15 and cold water may be operated by a cold water faucet handle 16.

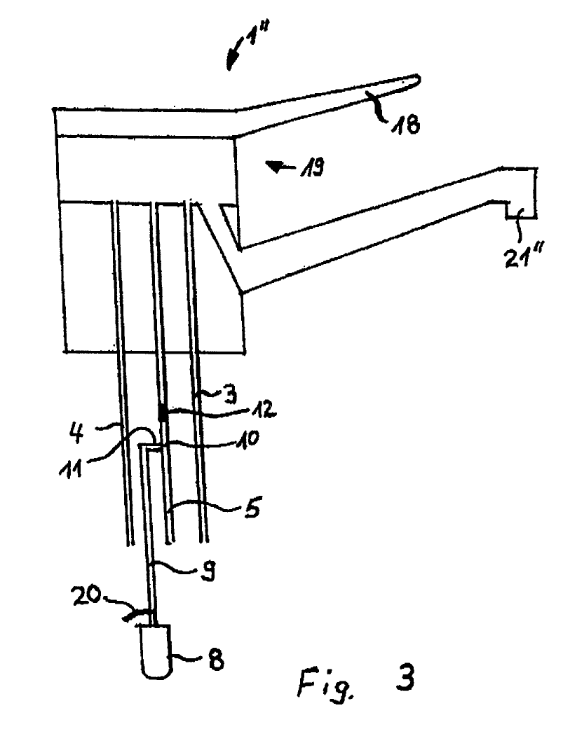

The control member of the second cold water feed 5 may, however, also be designed as single-hand lever 18 of a single-hand lever faucet 19 of a mixing assembly with additional function for the second cold water feed 5 for dispensing CO₂-containing cold water (FIG. 3).

The CO₂ supply container 8 may be designed as replaceable CO₂ bottle. The CO₂ supply container 8, or the CO₂ bottle, is connected via a quick-release coupling 20 with the CO₂ conduit 9. The CO₂ supply container 8 may, however, also be designed as refillable CO₂ tank.

Disposed upstream of the CO₂ supply container 8 in the direction of the water tap connection 2 is a pressure reducer (not shown) or flow rate controller (not shown). Furthermore, a manometer (not shown) may be disposed upstream of the CO₂ supply container 8.

In principle, it is also possible to arrange a distributor (not shown) downstream in the direction of the respective water tap connections 2 of the metering station 10, for connecting the second cold water feed 5 with a plurality of water tap connections 2 by means of distribution lines.

The second cold water feed 5 may be provided with a backflow prevention device 22 or a check valve, for preventing CO₂ containing cold water of the second cold water feed 5 from penetrating the cold water feed 3. This backflow prevention device 22 is suitably provided in the branch pipe 7.

For reasons of simple maintenance, the mixing assembly 1 can be provided with a metering station 10 which forms a structural unit 23 detachable from the cold water feed 3, 5. This structural unit 23 may, in particular, also incorporate the mixer 12 and also the backflow prevention device 22. This structural unit 23 is secured by means of connection parts 24, 25 between the cold water feed 3 and the second cold water feed 5, and serves to separate in a simple manner the components required for the mixture of cold water and CO₂, for example the mixer 12 and the CO₂ supply container 8 including the CO₂ conduit 9 from the mixing assembly 1 for optional repair or cleaning.

The connection parts 24,25 may be designed as releaseable screw connections. A first screw connection 26 is suitably positioned in the branch pipe 7 upstream of the metering station 10 as viewed in flow direction of the cold water. A second screw connection 27 forms the connection part 24 and is disposed in the reaction conduit 13. The mixer 12 is positioned within the structural unit 23 upstream of the second screw connection 27 in flow direction of the cold water.

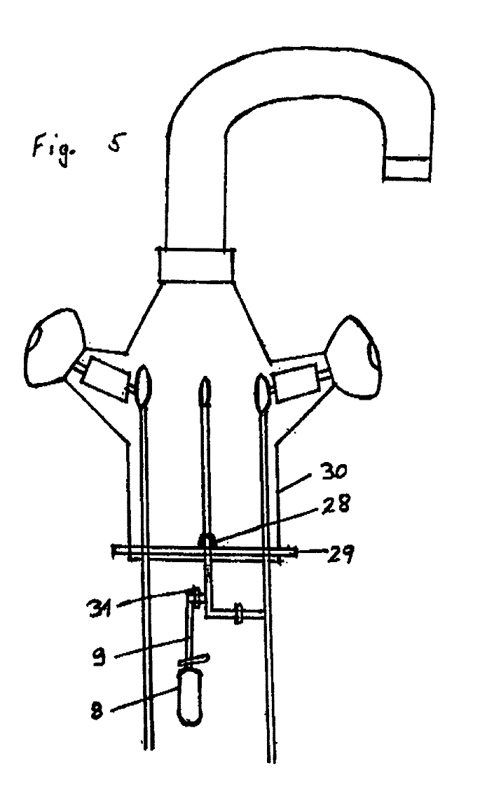

An especially simple configuration provides for the design of the screw connections 26, 27 as squeeze-type seal 28 (cf. FIG. 5). This squeeze-type seal 28 is implemented by means of a coupling nut 29 by which the sealing force, acting in sealing direction of the squeeze-type seal 28, is applied upon the squeeze-type seal 28. Suitably, the coupling nut 29 is operated outside of a casing 30 which surrounds the feeds 3, 4, 5.

A further simplification of the operation is implemented by providing the mixing assembly 1 with yet another releaseable connection 31 which is provided in the CO₂ conduit 9. By means of this releaseable connection 31, the CO₂ supply container 8 and the CO₂ conduit 9 can be separated from the metering station 10. For this purpose, the releaseable connection 31 is placed relatively near to the metering station 10 and permits a simple detachment of the CO₂ supply container 8 and the CO₂ conduit 9 from the metering station 10, so that the metering station 10, after removal of the CO₂ conduit 9 and the CO₂ supply container 8, can easily be subjected to a thorough inspection.

By opening the auxiliary valve 14, or by actuating the single-hand lever 18 into its additional operative position for dispensing from the second cold water feed 5, cold water mixed with CO₂ flows out of the spout 21. Thus, cold water enters from the cold water feed 3 via the branch pipe 7 into the metering station 10. CO₂ from the CO₂ supply or CO₂ supply container 8 is introduced into this cold water via the nozzle 11 of the metering station 10, while flowing through the second cold water feed 5, and is mixed in the mixer 12 with the cold water. After exiting the mixer 12, CO₂ further reacts in the reaction conduit 13, 13′ with the cold water and exits the spout 21, 21′ of the mixing assembly 1, 1′ as drinking water.

While the invention has been illustrated and described as embodied in a mixing assembly and method for dispensing cold water containing CO₂, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A mixing assembly, comprising a water tap connection with a first cold water feed; a second cold water feed; and a CO₂ supply connected to the second water feed.

2. The mixing assembly according to claim 1, and further comprising a metering station disposed in the second cold water feed, said CO₂ supply being connected via a CO₂ conduit to the metering station.

3. The mixing assembly according to claim 2, wherein the metering station is designed as a nozzle which projects into the second cold water feed.

4. The mixing assembly according to claim 3, wherein the nozzle is arranged radially to the second cold water feed.

5. The mixing assembly according to claim 2, and further comprising a mixer arranged between the metering station and the water tap connection.

6. The mixing assembly according to claim 5, wherein the mixer is designed as static mixer.

7. The mixing assembly according to claim 1, wherein the second cold water feed is connected to a main water line.

8. The mixing assembly according to claim 1, and further comprising a branch pipe for connecting the second cold water feed to the cold water feed.

9. The mixing assembly according to claim 2, wherein the second cold water feed forms a reaction conduit between the metering station and the water tap connection.

10. The mixing assembly according to claim 9, wherein the reaction conduit has the shape of a helix.

11. The mixing assembly according to claim 1, wherein the second cold water feed includes a control member at the water tap connection.

12. The mixing assembly according to claim 1, wherein the water tap connection includes a hot water feed.

13. The mixing assembly according to claim 12, wherein the water tap connection is designed as two-handle faucet for mixing cold water and hot water, said second cold water feed having an additional control member for dispensing CO₂ containing cold water.

14. The mixing assembly according to claim 12, wherein the water tap connection is designed as single-hand lever faucet, said second cold water feed being adapted for dispensing CO₂ containing cold water.

15. The mixing assembly according to claim 1, wherein the CO₂ supply is arranged in a CO₂ supply container.

16. The mixing assembly according to claim 15, wherein the CO₂ supply container is designed as exchangeable CO₂ bottle.

17. The mixing assembly according to claim 2, wherein the CO₂ supply is arranged in a CO₂ bottle, said CO₂ bottle being connectable via a quick-release coupling with the CO₂ conduit.

18. The mixing assembly according to claim 15, wherein the CO₂ supply container is designed as refillable CO₂ tank.

19. The mixing assembly according to claim 15, and further comprising a pressure reducer positioned upstream of the CO₂ supply container.

20. The mixing assembly according to claim 15, and further comprising a flow rate controller positioned upstream of the CO₂ supply container.

21. The mixing assembly according to claim 15, and further comprising a manometer positioned upstream of the CO₂ supply container.

22. The mixing assembly according to claim 2, and further comprising a distributor, positioned upstream of the metering station, for connecting the second cold water feed via distribution lines with a plurality of said one water tap connection.

23. The mixing assembly according to claim 1, wherein the second cold water feed includes a backflow prevention device.

24. The mixing assembly according to claim 2, wherein the metering station forms a structural unit which is detachable from the first and second cold water feeds.

25. The mixing assembly according to claim 24, wherein the mixer is integrated in the structural unit.

26. The mixing assembly according to claim 24, wherein the structural unit is inserted via connection parts between the first cold water feed and the second cold water feed.

27. The mixing assembly according to claim 26, wherein the connection parts are designed as releaseable screw connections.

28. The mixing assembly according to claim 27, and further comprising a branch pipe for connecting the second cold water feed to the cold water feed, a first one of said screw connections being positioned in the branch pipe upstream of the metering station in flow direction of the cold water.

29. The mixing assembly according to claim 27, wherein the second cold water feed forms a reaction conduit between the metering station and the water tap connection, a second one of said screw connections being positioned in the reaction conduit downstream of the metering station in flow direction of the cold water.

30. The mixing assembly according to claim 29, wherein the mixer is positioned upstream of the second screw connection in flow direction of the cold water.

31. The mixing assembly according to claim 29, wherein the second screw connection is designed as a squeeze-type seal.

32. The mixing assembly according to claim 31, and further comprising a coupling nut provided in sealing direction of the seal-type seal for applying the sealing force.

33. The mixing assembly according to claim 32, wherein the water tap connection includes a hot water feed, and further comprising a casing for accommodating the first and second cold water feeds and the hot water feed, said coupling nut being so placed as to be accessible from outside of the casing.

34. The mixing assembly according to claim 2, wherein the CO₂ supply is arranged in a CO₂ supply container, said CO₂ supply container being detachable from the metering station.

35. The mixing assembly according to claim 34, and further comprising a releaseable connection, provided in the CO₂ conduit, for attaching the CO₂ conduit from the metering station.

36. The mixing assembly according to claim 35, wherein the releaseable connection is provided immediately upstream of the metering station in flow direction of the CO₂ gas.

37. A method for dispensing CO₂-containing cold water from a water tap connection of a mixing assembly, having at least one cold water feed, comprising the steps of feeding CO₂ from a CO₂ supply in doses via a metering station to a second cold water feed, mixing CO₂ with cold water; and supplying the mixture via an additional valve to a spout of the water tap connection.

38. The method according to claim 37, wherein the cold water is mixed with CO₂ in a mixer positioned upstream of the metering station.

39. The method according to claim 37, wherein for further mixture of cold water and CO₂ a reaction time is maintained which is realized by a respective length of a reaction conduit.

40. The method according to claim 37, wherein for further mixture of cold water and CO₂ a reaction time is maintained which is realized by a respective reactor.
